(19) United States
(12) Patent Application Publication
(10) Pub. No.: US 2025/0173840 A1
(43) Pub. Date: May 29, 2025

(54) INFORMATION PROCESSING APPARATUS, LEARNING APPARATUS, AND INFORMATION PROCESSING METHOD

(71) Applicant: CANON KABUSHIKI KAISHA, Tokyo (JP)

(72) Inventors: Akane ISEKI, Kanagawa (JP); Yasuharu HIRADO, Tokyo (JP)

(21) Appl. No.: 18/953,168

(22) Filed: Nov. 20, 2024

(30) Foreign Application Priority Data
Nov. 28, 2023 (JP) 2023-201025
Nov. 13, 2024 (JP) 2024-198334

(51) Int. Cl. G06T 5/70; G06T 5/50; G06T 5/60

(52) U.S. Cl. CPC G06T 5/70; G06T 5/50; G06T 5/60; G06T 2207/20081; G06T 2207/20084; G06T 2207/20224

(57) ABSTRACT

An information processing apparatus comprises: a conversion unit configured to convert an input image of a first bit depth into a low-bit-depth image of a second bit depth lower than the first bit depth; an estimation unit configured to estimate a noise component map in the input image from the low-bit-depth image using a neural network (NN) of a third bit depth that is lower than the first bit depth and is not lower than the second bit depth; and a deriving unit configured to derive a noise-reduced image corresponding to the input image based on the input image and the noise component map.

### BACKGROUND OF THE INVENTION

### Field of the Invention

The present invention relates to an image processing technique for image-quality enhancing.

### Description of the Related Art

In recent years, in image-quality enhancing processing of improving the quality of an image, various methods using a neural network (NN) have been developed. The image-quality enhancing processing indicates image processing such as noise reduction, aberration correction, and demosaicing. In the methods using the NN, a calculation amount tends to be larger as image processing performance is higher. Thus, a weight reduction method of reducing the calculation amount while maintaining the performance has been extensively studied in order to enable processing in an incorporated apparatus. Jacob et al., “Quantization and Training of Neural Networks for Efficient Integer-Arithmetic-Only Inference”, CVPR2018 (non-patent literature 1) and Yamamoto et al., “Learnable Companding Quantization for Accurate Low-bit Neural Network”, CVPR2021 (non-patent literature 2) propose methods of reducing the weight by quantizing the weight or feature amount of the NN into a low-bit depth.

However, if quantization is performed by a simple method of, for example, thinning out values at equal intervals in quantization, the accuracy of the output degrades, as compared with the accuracy before quantization. If the weight or feature amount of the NN is quantized into a low-bit depth (for example, a bit depth lower than that of an image to be output) in the NN used for image-quality enhancing, the tones of the output from the NN are coarse and the accuracy of the output degrades. For example, if the quality of a RAW image is enhanced, the bit depth of the RAW image is 12 to 14 bits, and thus the NN having a bit depth of 12 to 14 bits or more is desirably used. If the NN whose weight or feature amount is quantized into a bit depth of 8 bits is used, an image output from the NN has 8-bit tones, which are coarser than the tones of an image to be originally estimated. Therefore, if the NN of a low-bit depth is used, the image-quality enhancing performance lowers, as compared with an NN having a bit depth equal to or higher than the bit depth of an image to be output.

### SUMMARY OF THE INVENTION

According to one aspect of the present invention, an information processing apparatus comprises: a conversion unit configured to convert an input image of a first bit depth into a low-bit-depth image of a second bit depth lower than the first bit depth; an estimation unit configured to estimate a noise component map in the input image from the low-bit-depth image using a neural network (NN) of a third bit depth that is lower than the first bit depth and is not lower than the second bit depth; and a deriving unit configured to derive a noise-reduced image corresponding to the input image based on the input image and the noise component map.

According to the present invention, a high-quality image is estimated by an NN having a low-bit depth.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the hardware arrangement of an information processing apparatus according to the first embodiment;

FIGS. 2A and 2B are block diagrams respectively showing the functional arrangements of the information processing apparatus at the time of inference and at the time of learning according to the first embodiment;

FIGS. 3A to 3C are a view and flowcharts for explaining the structure of a difference estimation NN and processes in a bit depth conversion layer and a final bit depth conversion layer according to the first embodiment;

FIGS. 4A and 4B are a graph and a table for explaining nonlinear conversion in bit depth conversion processing according to the first embodiment;

FIG. 5 is a flowchart of inference processing according to the first embodiment;

FIG. 6 is a flowchart of learning processing according to the first embodiment;

FIG. 7 is a graph for explaining a piecewise linear function used in bit depth conversion processing according to Modification 1;

FIG. 8 is a graph for explaining the relationship between a pixel value and a noise component; and

FIGS. 9A and 9B are a flowchart and a graph of image quantization processing according to Modification 3.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the present invention, an information processing apparatus that performs image-quality enhancing processing using a neural network (NN) will be exemplified below.

### <Overview>

The present invention relates to processing of estimating a quality-enhanced image from a low-quality image by machine learning. Image-quality enhancing from a low-quality image includes, for example, noise reduction (denoising) processing and aberration correction processing.

The first embodiment will describe inference processing using a noise reduction NN and a learning method of the noise reduction NN. Assume that the bit depth of an image to be processed is 14 bits, and the bit depth (to be referred to as “the bit depth of the NN” hereinafter) of the weight and intermediate feature amount of the NN is 8 bits. However, the bit depths are not limited to them. The type of the image to be processed may be a RAW image (for example, a mosaic image having a Bayer array) or an RGB image (demosaic image).

In the first embodiment, instead of directly estimating a quality-enhanced image (denoise image) by the NN, a noise component is estimated by the NN. Then, a denoise image is derived by subtracting the estimated noise component from a noisy image. This is because the variation width of the noise component is smaller than the range of a value that the pixel value of the image can take, and thus the noise component can relatively accurately be represented by even an 8-bit depth, as will be described below.

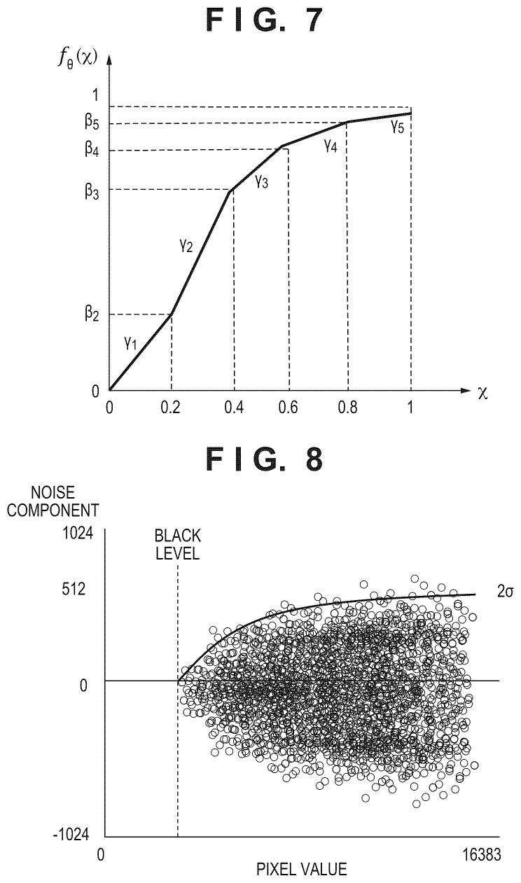

FIG. 8 is a graph for explaining the relationship between the pixel value and the noise component. More specifically, FIG. 8 is a graph exemplarily showing the distribution (variation) of noise generated in an image (14-bit RAW image) captured by a given image sensor. The abscissa represents the pixel value, and the ordinate represents the noise. A curve shown in FIG. 8 indicates a curve corresponding to 2σ (σ is the standard deviation of α value that the noise can take) with respect to the pixel value. It is apparent from FIG. 8 that the variation of the noise is larger as the pixel value is larger (=the pixel has a larger number of bits).

Each point on the graph is plotted by generating noise in accordance with a normal distribution having σ corresponding to each pixel value. In this example, it is known that even if the pixel value is a maximum value of 16,383 (=2¹⁴−1), 20 is about 512. This indicates that the values of the noise components fall within the range of about ±512 in about 90% of the plurality of pixels whose pixel values are 16,383. That is, the noise component in the 14-bit RAW image can sufficiently be represented by 10 bits (=2¹⁰−1 tones). Since a denoise image to be finally obtained is a 14-bit RAW image, if the denoise image is directly estimated by the NN of the 8-bit depth, it is necessary to convert 14 bits into 8 bits. On the other hand, if the NN of the 8-bit depth estimates the noise component, 10 bits are converted into 8 bits, and thus an error occurring in quantization is smaller than in a case where the denoise image is directly estimated. Therefore, a denoise image obtained by estimating a noise component by the NN of the 8-bit depth and subtracting the noise component from a noisy image can be expected to be a higher-quality image than the denoise image directly estimated by the NN of the 8-bit depth.

Furthermore, σ of noise is larger as the pixel value is larger but the ratio of noise to the pixel value is higher as the pixel value is smaller. Therefore, as for estimation of a noise component, it is important for image quality to accurately estimate noise having a small absolute value, that is generated in a region where the pixel value is small.

The hardware arrangement of the information processing apparatus will be described first. After that, the functional arrangements and operations in inference processing and learning processing will be described.

### <Hardware Arrangement>

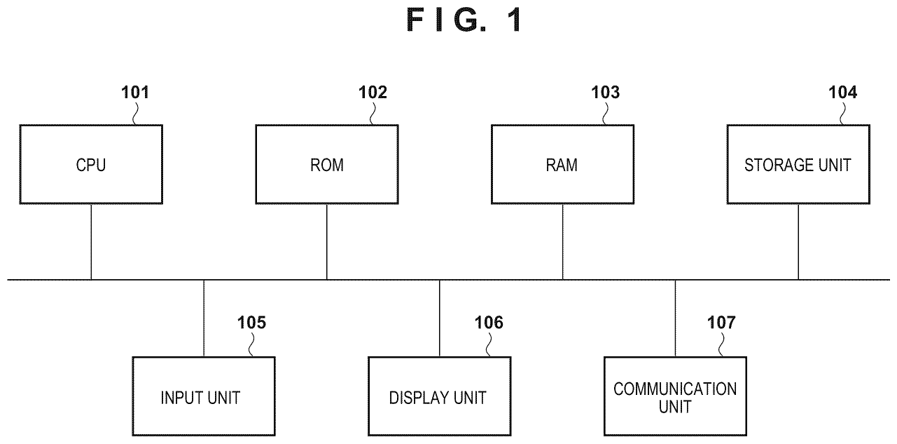

FIG. 1 is a block diagram showing the hardware arrangement of the information processing apparatus according to the first embodiment. Note that the same information processing apparatus or different information processing apparatuses may be used for inference processing and learning processing.

A CPU 101 controls the overall apparatus by executing control programs stored in a ROM 102. A RAM 103 temporarily stores various kinds of data from respective components. The RAM 103 functions as a work area of the CPU 101, and the control programs are deployed in the RAM 103 to be executable by the CPU 101. A storage unit 104 stores various kinds of data to be processed in this embodiment. For example, the storage unit 104 stores an image to undergo inference processing (noise reduction processing), an image used for learning processing, and various parameters. As a medium of the storage unit 104, an HDD, a flash memory, various kinds of optical media, and the like can be used.

### <Functional Arrangement at Time of Inference Processing>

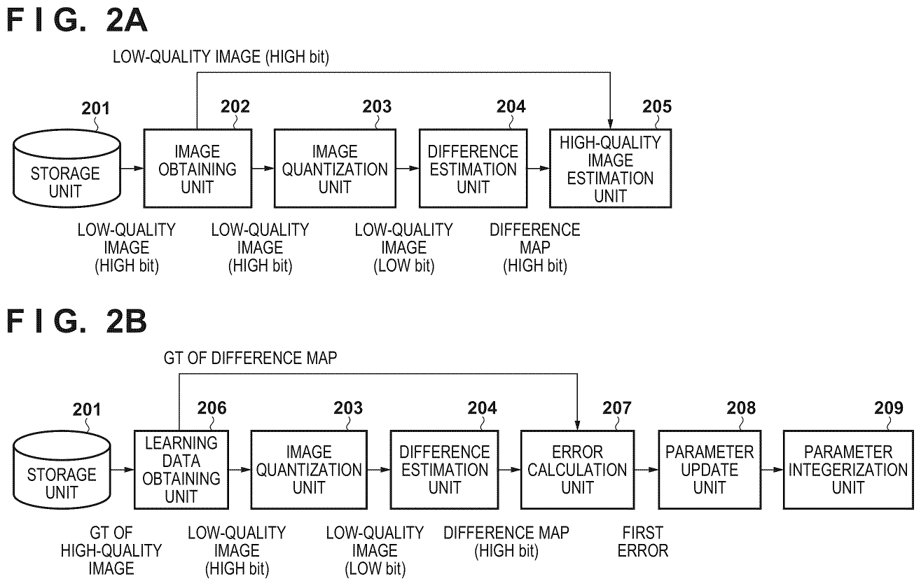

FIG. 2A is a block diagram showing the functional arrangement of the information processing apparatus at the time of inference. An information processing apparatus 1 includes a storage unit 201, an image obtaining unit 202, an image quantization unit 203, a difference estimation unit 204, and a high-quality image estimation unit 205. The respective functional components will briefly be described.

The image obtaining unit 202 obtains an input image (an image having a bit depth of 14 bits) to undergo noise reduction processing from the storage unit 201. This image will be referred to as a “noisy image” hereinafter. The noisy image is an image obtained by adding a “noise component” to an original image. The noise component is caused by, for example, an image capturing unit (an image sensor or the like). The original image will be referred to as a “clean image” hereinafter. As described above, in this inference processing, a noise component is estimated from the noisy image using the NN, and a clean image is derived by subtracting the noise component from the noisy image. Note that it may be impossible to derive completely the same clean image as the original image but the image is called the clean image for the sake of convenience.

The image quantization unit 203 performs quantization processing for the noisy image having a bit depth of 14 bits obtained from the image obtaining unit 202 to convert the image into a noisy image (low-bit-depth image) in which each pixel is represented by an unsigned 8-bit integer. In this embodiment, the same quantization method as that in a bit depth conversion layer 306 (to be described later) is used. However, the quantization method is not limited to this. For example, the image quantization unit 203 may include an NN having a bit depth of 14 bits or more. In this case, a 14-bit noisy image is input to the NN, and then quantization processing is performed for the output of the NN, thereby obtaining an 8-bit noisy image. Note that in this example, the bit depth of the NN is made to match the bit depth (8 bits) of the low-bit-depth image but the bit depths may be different from each other. The bit depth of the NN need only be lower than the bit depth of the input image and equal to or higher than the bit depth of the low-bit-depth image.

The difference estimation unit 204 inputs an 8-bit noisy image 301 obtained from the image quantization unit 203 to the NN of the 8-bit depth, and estimates a difference map (noise component map) in which each pixel has 8-bit tones and a range represented by a signed 10-bit integer.

The high-quality image estimation unit 205 subtracts, from the 14-bit noisy image obtained from the image obtaining unit 202, the noise component map, estimated by the difference estimation unit 204, in which each pixel has 8-bit tones and a range represented by a signed 10-bit integer, thereby deriving a 14-bit clean image as a noise-reduced image.

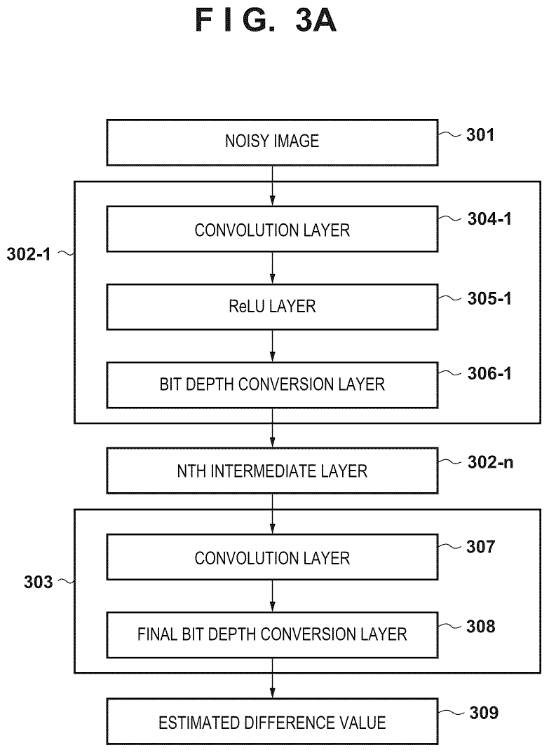

FIG. 3A is a view for explaining the structure of a difference estimation NN having a bit depth of 8 bits. There exist a first intermediate layer 302-1 to an nth intermediate layer 302-n as intermediate layers, and there finally exists a final layer 303. The intermediate layer is an NN in which a weight is a signed 8-bit integer and an output is an unsigned 8-bit integer. The final layer 303 is an NN in which a weight is a signed 8-bit integer and an output has 8-bit tones and a range represented by a signed 10-bit integer. In the difference estimation NN formed by the intermediate layers and the final layer 303, the unsigned 8-bit noisy image 301 is input to the first intermediate layer 302-1, and the final layer 303 outputs an estimated difference value 309 that has 8-bit tones and a range represented by a signed 10-bit integer. In this example, the estimated difference value indicates the estimated value 309 of the noise component map. The number of intermediate layers may be arbitrary.

The first intermediate layer 302-1 to the nth intermediate layer 302-n have a common internal arrangement, and the internal arrangement of each intermediate layer will be described by exemplifying the intermediate layer 302-1 as a representative example.

The intermediate layer 302-1 is formed by a convolution layer 304-1, an ReLU layer 305-1, and a bit depth conversion layer 306-1.

The convolution layer 304-1 performs convolution processing as a linear conversion having a weight of a signed 8-bit integer. In the convolution processing, the noisy image 301 of the unsigned 8-bit integer is multiplied by the weight (including a bias) of the signed 8-bit integer, and thus the result of the calculation is a signed 16-bit integer.

The ReLU layer 305-1 performs Rectified Linear Unit (ReLU) processing as nonlinear conversion. Since the ReLU is processing of outputting 0 as a value equal to or less than 0, the intermediate feature of the input signed 16-bit integer is converted into an unsigned 15-bit integer by the ReLU.

The bit depth conversion layer 306-1 performs processing of converting data of the unsigned 15-bit integer obtained in the ReLU layer 305-1 into an unsigned 8-bit integer. To convert the bit depth, a method of uniformly quantizing 15 bits into 8 bits is used in this embodiment, but a nonuniform quantization method represented by non-patent literature 2 may be used. Details of the processing in the bit depth conversion layer 306-1 will be described later with reference to FIG. 3B.

The arrangement of the final layer 303 will be described next. The final layer 303 is formed by a convolution layer 307 and a final bit depth conversion layer 308.

The convolution layer 307 performs convolution processing having a weight of an 8-bit integer, similar to the convolution layer 304.

The final bit depth conversion layer 308 converts the noise component map of the signed 16-bit integer into a noise component map in which each pixel has 8-bit tones and a range represented by signed 10-bit integer. To convert 16-bit tones into 8-bit tones, the nonuniform quantization method represented by non-patent literature 2 is used. The nonuniform quantization method is a method of reducing a quantization error by devising a tone expression at the time of thinning out and finely representing the effective range of accuracy of the input data, and it can be expected to improve the accuracy of the quantization NN. In the final bit depth conversion layer 308, the nonuniform quantization method is devised to accurately quantize a noise component effective for improvement of image quality. Details of the processing in the final bit depth conversion layer 308 will be described later with reference to FIG. 3C. Note that the structure of the NN is not limited to that shown in FIG. 3A, and the U-Net structure or the like may be used. The convolution layers 304 and 307 and the ReLU layer 305 are not limited to these, and other linear conversion/nonlinear conversion can be used. The type of each of the intermediate layers 302 and the number of layers are not limited, and need not be the same as the final layer 303. The bit depth of the noisy image 301 may be higher than 8 bits.

### <Operation at Time of Inference Processing>

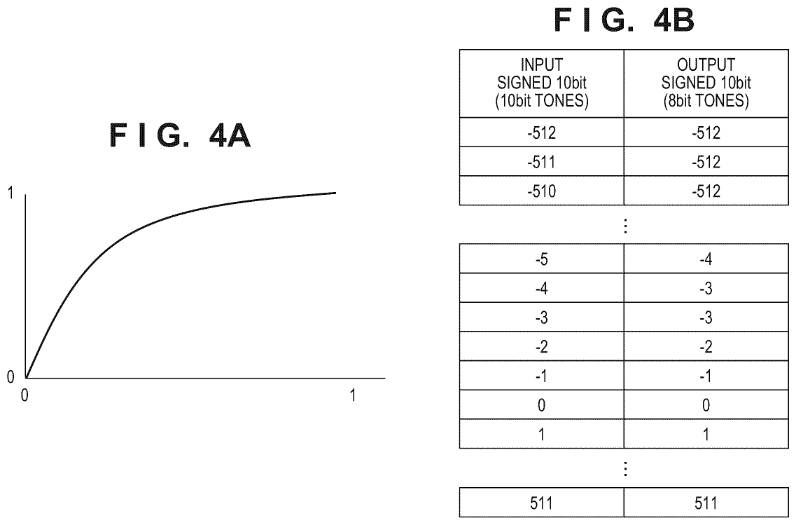

FIG. 5 is a flowchart of inference processing executed by the information processing apparatus. However, the information processing apparatus need not always execute all steps described in this flowchart.

In step S501, the image obtaining unit 202 obtains a noisy image to undergo noise reduction from the storage unit 201. The noisy image is a RAW image, and each pixel has an unsigned 14-bit integer.

In step S502, the image quantization unit 203 converts the noisy image of the unsigned 14-bit integer obtained in step S501 into the noisy image 301 of the unsigned 8-bit integer.

In step S503, the difference estimation unit 204 obtains, from the noisy image 301 of the unsigned 8-bit integer obtained in step S502, an estimated value of a noise component map having 8-bit tones and a range represented by a signed 10-bit integer.

More specifically, the difference estimation unit 204 inputs the noisy image 301 of the unsigned 8-bit integer obtained in step S502 to the difference estimation NN shown in FIG. 3A, and subsequently performs the processes in the intermediate layers 302 and the final layer 303. This outputs the estimated difference value 309 (noise component map) having 8-bit tones and a range represented by a signed 10-bit integer. A case where the bias of the convolution layer 304 or 307 is “O” and the weight is represented by the “signed 8-bit integer” will be described.

At this time, as a result of a convolution operation of the weight of the signed 8-bit integer of the convolution layer 304 or 307 and the intermediate feature or the noisy image 301 of the unsigned 8-bit integer, the obtained output is an intermediate feature of a signed 16-bit integer. When the ReLU layer 305 is applied to the output of the convolution layer 304, a negative value is converted into “O” and a positive value is output intact, and thus the obtained output is represented by an unsigned 15-bit integer. The bit depth conversion layer 306 converts the unsigned 15-bit integer obtained in the ReLU layer 305 into an unsigned 8-bit integer, and the final bit depth conversion layer 308 converts the signed 16-bit integer obtained in the convolution layer 307 into a value having 8-bit tones and a range represented by a signed 10-bit integer.

FIG. 3B is a flowchart for explaining the processing in the bit depth conversion layer 306. This processing is processing of converting the input of the unsigned 15-bit integer into an unsigned 8-bit integer.

In step S311, the unsigned 15-bit integer output from the ReLU layer 305 is normalized. More specifically, processing given by equation (1) is performed for an intermediate feature x output from the ReLU layer 305.

$${x}_{inter}^{′} = {x}_{inter} / β \qquad ( 1 )$$

where β is 2¹⁵−1. With this processing, the output is a real number of 15-bit tones having a range of [0, 1]. In this embodiment, normalization is performed by β of 2¹⁵−1. However, xᵢₙₜₑᵣ may be clipped by an arbitrary minimum value and maximum value, and normalized by the difference between the minimum value and the maximum value, thereby obtaining a real number of less than 15-bit tones having a range of [0, 1].

In step S312, the normalized intermediate feature obtained in step S311 is converted into an unsigned 8-bit integer. More specifically, processing given by equation (2) is applied to the output in step S311.

$${x}_{inter}^{′′} = ⌈ {s}_{inter} \cdot {x}_{inter}^{′} ⌋ \qquad ( 2 )$$

where sᵢₙₜₑᵣ is 2⁸−1, and the parentheses on the right-hand side represent processing of rounding off a fractional part. By setting the scale of the real number to a range of [0, 2⁸−1], and then rounding off a fractional part, an unsigned 8-bit integer is obtained. This processing converts the unsigned 15-bit integer output from the ReLU layer 305 into an unsigned 8-bit integer. In this embodiment, the processing in the bit depth conversion layer 306 uses the uniform quantization method that does not perform nonlinear processing at the time of quantization, but the nonuniform quantization method described in non-patent literature 2 may be used.

FIG. 3C is a flowchart for explaining the processing in the final bit depth conversion layer 308. This processing is processing of converting the input represented by a given bit depth into data of a different bit depth. At this time, tone conversion is performed to nonuniformly express tones (finely express tones within a given range and coarsely express tones within another range). This tone conversion corresponds to the nonuniform quantization method described in non-patent literature 2.

In step S321, the final bit depth conversion layer 308 normalizes the intermediate feature obtained in the convolution layer 307. The intermediate feature is represented by x, and x indicates a map having a width W, a height H, and a channel count of 1. Normalization is processing of taking the absolute value of the intermediate feature, clipping the value to a or less, and then normalizing the value to a range of [0, 1], given by:

$${x}^{′} = \{ \begin{matrix}\vert x \vert / α & if \vert x \vert < α \\ 1 & otherwise\end{matrix} \qquad ( 3 )$$

In this example, the parameter α of the clipping range is 2⁹−1 corresponding to 2σ of the noise distribution, as described above. The parameter α may be decided by 3σ or the like, and may be optimized by Bayesian optimization from a plurality of candidates so as to improve the quality of an evaluation image prepared in advance. At this time, a general quantitative indicator such as a PSNR may be used as an image quality index as a target of optimization but the index is not limited to this.

In step S322, the final bit depth conversion layer 308 applies nonlinear conversion f_{θ} to the normalized intermediate feature obtained in step S321.

$${x}^{′′} = {f}_{θ} ( {x}^{′} ) \qquad ( 4 )$$

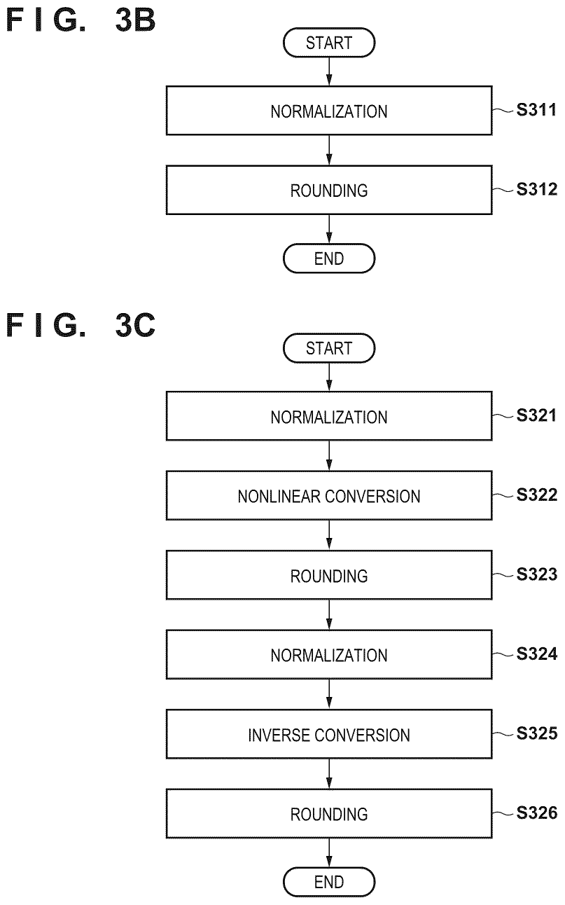

FIGS. 4A and 4B are a graph and a table for explaining the nonlinear conversion (step S322) processing in the bit depth conversion processing. This embodiment will describe a case where nonlinear conversion can be represented by a tone curve shown in FIG. 4A. First, the normalized map x′ obtained in step S321 is input to the tone curve, thereby obtaining a nonlinearly converted map. With the tone curve, conversion is performed to obtain finer tones as the value is lower and to obtain coarser tones as the value is higher. The nonlinearly converted map has a range of [0, 1], and takes a 9-bit real number.

In step S323, the final bit depth conversion layer 308 converts the output in step S322 into an unsigned 7-bit integer. More specifically, equation (5) below is used.

$${x}^{′′′} = ⌈ {s}_{1} \cdot {x}^{′′} ⌋ \qquad ( 5 )$$

where s₁=2⁷−1, and the parentheses on the right-hand side represent processing of rounding off a fractional part. By setting the scale of the 7-bit real number to a range of [0, 2⁷−1], and then rounding off a fractional part, an unsigned 7-bit integer is obtained. Note that since the absolute value of x is taken in step S321, a 7-bit integer is obtained instead of an 8-bit integer. Although 16-bit data is converted into 7-bit data by the processes of steps S321 to S323, the data is clipped by the parameter α (2⁹−1) in step S321, and thus 9-bit data is actually converted into 7-bit data. Furthermore, degradation in image quality caused by conversion into a low-bit data is suppressed by performing the nonlinear processing in step S322 to convert, with fine tones, noise having a small absolute value that largely contributes to image quality.

In step S324, the 7-bit integer obtained in step S323 is normalized again. The same value as that of s₁ in step S323 is used as the coefficient of normalization to set the range of the normalized map to [0, 1] to take a 7-bit real number.

$${x}^{′′′′} = {x}^{′′′} / {s}_{1} \qquad ( 6 )$$

In step S325, the final bit depth conversion layer 308 applies inverse conversion f_{θ}⁻¹ of the nonlinear conversion used in step S322 to the output obtained in step S323. The value non-linearized in step S322 is returned to be linear by applying f_{θ}⁻¹. The map returned to be linear has a range of [0, 1], and takes a 7-bit real number.

$${x}^{′′′′′} = {f}_{θ}^{- 1} ( {x}^{′′′′} ) \qquad ( 7 )$$

In step S326, the 7-bit real number output in step S325 is converted into a signed 10-bit integer of 8-bit tones. More specifically, equation (8) below is used.

$${x}^{′′′′′′} = sign ( x ) \cdot ⌈ {s}_{2} \cdot {x}^{′′′′′} ⌋ \qquad ( 8 )$$

where s₂=2⁹−1, and the parentheses on the right-hand side represent processing of rounding off a fractional part. By setting the scale of the real number to a range of [0, 2⁹−1], and then rounding off a fractional part, an integer of 7-bit tones having the range of [0, 2⁹−1] is obtained. Since sign (x) is processing of outputting the sign of x, a finally obtained value is an integer of 8-bit tones having a range of [−2⁹, 2⁹−1].

Since in the difference estimation NN, the input noisy image 301 and the weights and feature amounts in the intermediate layers are represented by 8 bits, it is difficult to accurately infer 9- or more-bit tones as a final output by a high-speed model. To cope with this, the nonlinear processing is applied to perform conversion into a low-bit depth, and then inverse nonlinear processing is applied to return the range to the original bit depth, as in the processes in steps S321 to S326. With this processing, it is possible to convert the tones of the noise component into a low-bit depth, and to represent, by finer tones, noise having a small absolute value that largely contributes to image quality, thereby suppressing degradation in image quality caused by conversion into low-bit tones. Note that in this embodiment, data is converted into 8-bit data by the processes in steps S321 to S323 of converting data into low-bit data by nonlinear conversion. But the present invention is not limited to 8 bits, and any bit depth equal to or lower than the parameter α used for clipping in step S321 may be used.

The actual noise component has a 15-bit integer having a range of [−2¹⁴, 2¹⁴−1], and the noise component estimated in step S326 has an integer of 8-bit tones having a range of [−2⁹, 2⁹−1]. The actual noise component and the estimated noise component are different only in the range that can be taken, and the estimated noise component may also be handled as data having a bit depth of 15 bits. That is, when subtracting the noise component from the noisy image, the numerical value may be subtracted intact.

Processing composed of steps S321 to S326 may be implemented by performing an arithmetic operation or by using a lookup table (LUT) shown in FIG. 4B. This can accelerate these processes. In this LUT, a region where the absolute value of noise is small is converted with fine tones, and noise is converted with coarser tones as the absolute value of noise is larger. If the LUT is used, input x is clipped by the positive/negative of the parameter α, and converted by the LUT. By using the LUT shown in FIG. 4B, the value range in which the influence of a quantization error on the noise component is relatively large can be represented by relatively fine tones.

In step S504, the high-quality image estimation unit 205 subtracts the estimated value of the noise component map obtained in step S503 from the 14-bit noisy image obtained in step S501. This derives the estimated value of a denoise image as an image obtained by reducing noise from the noisy image.

### <Functional Arrangement at Time of Learning Processing>

This embodiment assumes that learning is performed by the framework of pseudo-quantization learning, as in non-patent literature 1. In pseudo-quantization learning, the weight and intermediate feature of the model are different from those at the time of inference, and data represented by not an integer but a floating-point number is quantized into 8-bit tones in a pseudo manner and used. A value quantized into 8-bit tones is used when calculating a loss at the time of forward propagation, and a 32-bit value or the like before quantization is used at the time of backpropagation, thereby making it possible to make a small update of the parameter, and reduce an error at the time of inference. A model obtained by performing learning by the framework of pseudo-quantization learning and then performing conversion into an integer using a parameter integerization unit 209 (to be described later) is used at the time of inference.

FIG. 2B is a block diagram showing the functional arrangement of the information processing apparatus at the time of learning. The information processing apparatus 1 includes the storage unit 201, a learning data obtaining unit 206, the image quantization unit 203, the difference estimation unit 204, an error calculation unit 207, a parameter update unit 208, and the parameter integerization unit 209. The storage unit 201 and the image quantization unit 203 are the same as those (FIG. 2A) at the time of inference and a description thereof will be omitted.

The learning data obtaining unit 206 obtains a clean image as an ideal image without noise from the storage unit 201. Then, an artificially generated noise component is added to the clean image, thereby generating a noisy image as an image to undergo noise reduction. The clean image and the noisy image have a 14-bit depth. Note that at the time of generating a noisy image, a noise component is added and a value exceeding the upper limit value of 14 bits is clipped.

The difference estimation unit 204 obtains a model of the difference estimation NN from the storage unit 201. Then, the noisy image of the 8-bit depth obtained from the image quantization unit 203 is input to the NN of the 8-bit depth, thereby estimating a noise component map having 8-bit tones and a range represented by a signed 10-bit integer.

As the weight and intermediate feature of the model of the difference estimation NN, data represented by not an integer but a floating-point number is quantized into 8-bit tones in a pseudo manner and used, unlike data at the time of inference.

The error calculation unit 207 calculates a loss with respect to the estimation result of the noise component map. More specifically, the error calculation unit 207 calculates an error between Ground Truth (GT) obtained by the learning data obtaining unit 206 and the estimated value of the noise component map having 8-bit tones and a range represented by a signed 10-bit integer and estimated by the difference estimation unit 204. A detailed calculation method will be described later.

The parameter update unit 208 updates the parameters of the difference estimation NN shown in FIG. 3A based on the error obtained by the error calculation unit 207, and stores the updated parameter in the storage unit 201.

The parameter integerization unit 209 quantizes the weight and output of the difference estimation NN that has undergone pseudo-quantization learning, and performs conversion into an integer. A known quantization method of the NN is applied and a detailed description will be omitted. This obtains the same output before and after conversion into an integer.

### <Operation at Time of Learning Processing>

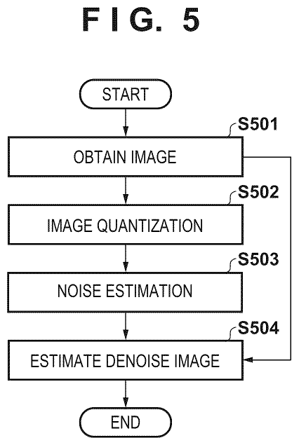

FIG. 6 is a flowchart of learning processing of the NN executed by the information processing apparatus. However, the information processing apparatus need not always execute all steps described in this flowchart.

In step S601, the learning data obtaining unit 206 obtains, from the storage unit 201, a clean image as an ideal image without noise, and the GT of the noise component map that has the same size as that of the clean image and is to be added to the clean image. The noise component map may be generated by, for example, calculating noise intensity by a function (or table) to which the luminance of the clean image is input. By adding the respective pixels in the noise component map and the clean image, a noisy image is obtained. In this example, the noisy image is a RAW image, and has a bit depth of 14 bits.

In step S602, the image quantization unit 203 converts the noisy image of the 14-bit depth obtained in step S501 into a noisy image of an 8-bit depth, and outputs it.

In step S603, by the same procedure as in step S503, the difference estimation unit 204 obtains an estimated value of a noise component map having a 14-bit depth. That is, a noise component map having 8-bit tones and a range represented by a signed 10-bit integer is estimated from the noisy image of the 8-bit depth obtained in step S502.

In step S604, the error calculation unit 207 calculates a loss Loss₁ with respect to the estimation result of the noise component map. The purpose is to advance learning so as to correctly estimate a clean image as the difference between the noisy image and noise by correctly estimating a noise component in the noisy image. In this embodiment, as given by equation (9) below, Loss₁ is obtained by calculating the L1-distance as the sum of the absolute values of the differences between elements in an estimation result C_{inf} of the noise component map obtained in step S603 and a noise component map C_{gt} as the GT obtained in step S601. However, the type of the loss is not limited to this.

$${Loss}_{1} = {\sum }_{i} \vert {C}_{inf}^{i} - {C}_{gt}^{i} \vert \qquad ( 9 )$$

In step S605, the parameter update unit 208 updates the parameters of the NN using backpropagation based on the loss Loss₁ calculated in step S604. The updated parameter indicates the weight of the convolution layer 304 or 307 forming the NN shown in FIG. 3A.

In step S606, the parameter update unit 208 saves the updated parameter of the NN in the storage unit 201. After that, the weight is loaded to the NN. Steps S601 to S606 are learning of one iteration.

In step S607, the parameter update unit 208 determines whether to end learning. It may be determined to end learning, by, for example, detecting a fact that the value of the loss obtained by equation (9) becomes smaller than a predetermined threshold. Alternatively, if learning is performed a predetermined number of times, it may be determined to end learning. Note that if the learning loss converges and learning ends, the parameter integerization unit 209 converts the NN into an integer NN.

As described above, according to the first embodiment, at the time of inference processing, a noise component is estimated by the NN of a bit depth lower than the bit depth of an image to be processed. Then, a denoise image is derived by subtracting the estimated noise component from a noisy image. At this time, a clip value of the noise component is set in accordance with a noise model. This can maintain high noise reduction performance in image-quality enhancing processing using the NN of the low-bit depth. Furthermore, by applying the nonuniform quantization method in the final layer of the NN, the noise component can accurately be represented.

### (Modification 1)

Modification 1 will describe a form in which a piecewise linear function is used in the final bit depth conversion layer 308 of the final layer 303. That is, a piecewise linear function is used as the nonlinear conversion f_{θ}. By using a piecewise linear function, it is possible to more freely set a range of the input where fine tones are set.

Note that as the piecewise linear function, a function that defines the inclination of each of sections divided at equal intervals may be used, as in non-patent literature 2. At this time, a section whose inclination is larger is represented by finer tones.

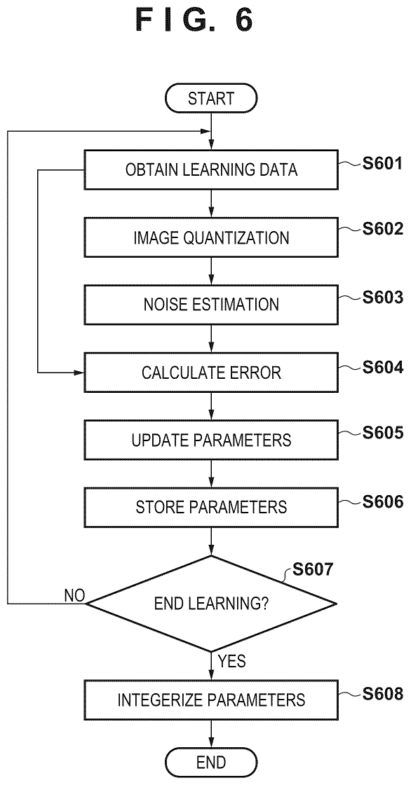

FIG. 7 is a graph for explaining a piecewise linear function used for the bit depth conversion processing in the final bit depth conversion layer 308. This piecewise linear function has five sections obtained by dividing the definition range of [0, 1] of the input at equal intervals, and an inclination γ₂ of the second section among inclinations γᵢ (i=1 to 5) of the sections is largest. By using the piecewise linear function, the noise component map output from the final bit depth conversion layer 308 is a map in which the tones of the range of the second section are represented most finely.

In a case where a function obtained by performing piecewise linear approximation for the tone curve of the first embodiment is used, the output finally obtained from the final bit depth conversion layer 308 is converted so as to obtain fine tones with respect to the small input and coarse tones with respect to the large input. The inclination of each section of the piecewise linear function may be obtained by Bayesian optimization or the like, or may be optimized to improve the quality of an evaluation image prepared in advance by deciding a plurality of candidates. At this time, a general quantitative indicator such as a PSNR may be used as an image quality index as a target of optimization.

Furthermore, the parameter of the piecewise linear function may be learned by backpropagation, as in non-patent literature 2. The inclination of each section of the piecewise linear function may be decided in consideration of the relationship between the magnitude of the noise component of a given pixel and the degree of influence (N/S ratio or the like) on the image quality of the pixel. For example, if a graph (to be referred to as a noise component-image quality index graph hereinafter) in which the abscissa represents the magnitude of the noise component and the ordinate represents the image quality index is not a monotonically increasing graph and has a local maximal value, the tones of a range near the noise component that gives the local maximum value may be converted finely.

As described above, according to Modification 1, by using the piecewise linear function as the nonlinear conversion fe, the degree of freedom of a shape becomes high, and the degree of freedom of a tone expression becomes high, as compared with the first embodiment. This can effectively suppress degradation in image quality caused by quantization. By using the method disclosed in non-patent literature 2, the parameter such as the inclination of the piecewise linear function can be learned by backpropagation together with the weight of the NN, and it is possible to efficiently obtain a tone expression optimum for improving image quality.

In Modification 1 described above, when learning the piecewise linear function and the weight of the NN, the error calculation unit 207 may calculate, in step S604, the loss Loss₁ with respect to the estimation result of the noise component map, as follows. More specifically, C_{inf} obtained in step S603, C_{gt} obtained in step S601, and a weighting map w having the same width and height as those of the clean image used to generate C_{gt} and having different values for respective pixels are prepared. Then, weighting is performed for each pixel with respect to the loss that makes C_{inf} and C_{gt} close to each other. An example in a case where the L1-distance is used for the loss is given by:

$${Loss}_{1} = {\sum }_{i} {w}^{i} \vert {C}_{inf}^{i} - {C}_{gt}^{i} \vert \qquad ( 10 )$$

A weighting map wi may be decided in accordance with the relationship between the image quality index and a pixel value I. For example, if the image quality index is represented by a function g(I) of the pixel value I, the respective pixel values of the clean image obtained from the storage unit 201 in step S601 may be input to the function g(I), thereby obtaining a map having the same width and height. A map obtained by performing normalization by dividing the values of the obtained map by the maximum value of the map may be set as a weighting map.

For example, if a graph in which the abscissa represents the pixel value and the ordinate represents the image quality index g(I) is not a monotonically increasing graph and has a local maximal value, a pixel having a pixel value closer to the local maximum value of the graph has a larger weight wi in the loss calculation of equation (10). Therefore, learning about these pixels preferentially advances. This promotes learning for improving the image quality of a region where noise influencing image quality is conspicuous in learning of the weight of the NN and the parameter of nonlinear conversion.

As described above, according to the modification, the loss is weighted so that noise estimation accuracy is higher for a pixel having a pixel value contributing to image quality more largely. This can focus on improving denoise accuracy of a region with high image quality improving effect.

### (Modification 2)

In Modification 2, at the time of learning processing, step S322 in the final bit depth conversion layer 308 forming the final layer 303 is replaced by identity mapping to implicitly perform nonlinear conversion in the NN. That is, unlike the first embodiment, nonlinear conversion in step S322 is not explicitly performed. Thus, at the time of inference processing, it is possible to accurately represent a noise component with less tones while avoiding an increase in processing load caused by nonlinear conversion, and it can be expected to improve the denoise accuracy. Different points from the processing of the first embodiment will be described below.

### <Operation at Time of Learning Processing>

In step S601, the learning data obtaining unit 206 obtains, from the storage unit 201, a clean image as an ideal image without noise, and a noise component map that has the same size as that of the clean size and is to be added to the clean image. Then, a noisy image is obtained by adding the respective pixels in the noise component map and the clean image. In this example, the noisy image is a RAW image, and has a bit depth of 14 bits.

In step S603, by the same procedure as in step S503, the difference estimation unit 204 obtains the estimated value of the noise component map having 8-bit tones and a range represented by a signed 10-bit integer. However, in this embodiment, when performing the processing in the final bit depth conversion layer 308 of the difference estimation NN in step S503, nonlinear conversion applied in the nonlinear conversion processing in step S322 is replaced by identity mapping. The processes in steps S324 to S326 are performed only at the time of inference processing and are not performed at the time of learning processing.

In step S604, the error calculation unit 207 calculates the loss Loss₁ with respect to the estimation result of the noise component map. The GT of the noise component map used to calculate Loss undergoes nonlinear conversion in advance to be converted into a signed 8-bit integer. More specifically, the noise component map obtained in step S601 undergoes nonlinear conversion of the noise component map and conversion into a singed 8-bit integer, similar to the processes in steps S321 to S323. This is used as the GT of the noise component map.

The type of nonlinear conversion may be the tone curve used in the first embodiment but is not limited to this. The loss Loss₁ is defined to be smaller as the estimated value of the noise component map obtained in step S603 is closer to the GT of the noise component map. For example, the L1-distance as the sum of the differences between the absolute values of the respective elements may be calculated, similar to the first embodiment, but the type of the loss is not limited to this.

### <Operation at Time of Inference Processing>

In step S503, the difference estimation unit 204 changes the processing in the final bit depth conversion layer 308 of the difference estimation NN. More specifically, the processing in step S322 performed in the first embodiment is not executed. This is because the NN is learned so as to directly output a result of performing nonlinear conversion at the start of FIG. 3C, by performing the above-described learning processing of this embodiment.

As described above, the processes in steps S324 to S326 that are not performed in the learning processing are executed at the time of inference processing.

As described above, according to Modification 2, it is configured to implicitly perform nonlinear conversion in the NN in the final bit depth conversion layer 308 at the time of learning processing. Thus, at the time of inference processing, it is possible to accurately represent a noise component with less tones while avoiding an increase in processing load caused by nonlinear conversion, and it can be expected to improve the denoise accuracy.

### (Modification 3)

In Modification 3, a method of obtaining an unsigned 8-bit image by the nonuniform quantization method by applying nonlinear processing to a 14-bit noisy image in the image quantization unit 203 will be described.

The difference estimation unit 204 represents, by finer tones, noise having a small absolute value that largely contributes to image quality. To do this, it is desirable to convert input data into 8-bit data in a suitable state. More specifically, it is desirable to represent, by finer tones, a low-luminance region where the ratio of noise to the pixel value is high.

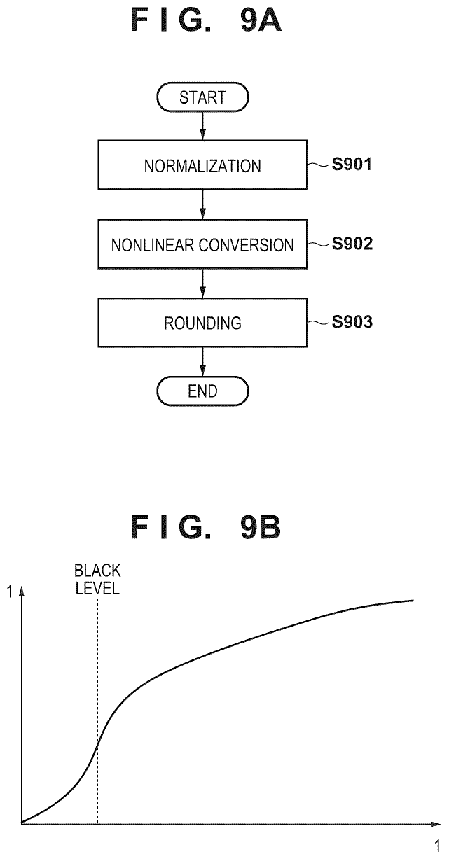

FIG. 9A is a flowchart of the processing of the image quantization unit 203 according to this embodiment.

In step S901, the 14-bit noisy image is normalized. More specifically, processing given by equation (11) below is performed for the 14-bit noisy image.

$${x}_{input}^{′} = {x}_{input} / γ \qquad ( 11 )$$

where γ is 2¹⁴−1. With this processing, the output is converted into a real number of 14-bit tones having a range of [0, 1].

In step S902, nonlinear conversion f_{Φ} is applied to the normalized noisy image obtained in step S901.

$${x}_{input}^{′′} = {f}_{Φ} ( {x}_{input}^{′} ) \qquad ( 12 )$$

FIG. 9B is a graph of the nonlinear conversion f_{Φ} according to this embodiment. Nonlinear conversion performs conversion to obtain finer tones near the black level (OB level). The black level is a value that is a numerical value within the 14-bit range and serves as a reference of black. A pixel value equal to or lower than the black level is finally determined as black. The image is converted into a digital signal by an image sensor, but if a negative noise amount generated by the image sensor is large, a pixel value of an object in a low-luminance portion may be lower than the black level. If a noise component is estimated from the noisy image, a low-luminance pixel in which the ratio of noise to the pixel value is high is important for image quality, and a portion around the black level in the input image corresponds to this. Therefore, it is important to convert the pixel value close to the black level into finer tones. In this embodiment, assume that the black level is 2,048.

The nonlinearly converted noisy image has a range of [0, 1], and takes a 14-bit real number.

In step S903, the nonlinearly converted noisy image obtained in step S902 is converted into an unsigned 8-bit integer. More specifically, processing given by equation (13) below is applied to the output in step S902.

$${x}_{input}^{′′′} = ⌈ {s}_{input} \cdot {x}_{input}^{′′} ⌋ \qquad ( 13 )$$

where sᵢₙₚᵤₜ=2⁸−1, and the parentheses on the right-hand side represent processing of rounding off a fractional part. By setting the scale of the 14-bit real number to a range of [0, 2⁸−1], and then rounding off a fractional part, an unsigned 8-bit integer is obtained.

As described above, according to Modification 3, the nonlinear processing is applied to the 14-bit noisy image in the image quantization unit 203, thereby obtaining an unsigned 8-bit image by the nonuniform quantization method. This can accurately represent a noise component, and it can be expected to improve the denoise accuracy.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-201025, filed Nov. 28, 2023, and Japanese Patent Application No. 2024-198334, filed Nov. 13, 2024, which are hereby incorporated by reference herein in their entirety.

What is claimed is:

1. An information processing apparatus comprising:
a conversion unit configured to convert an input image of a first bit depth into a low-bit-depth image of a second bit depth lower than the first bit depth;
an estimation unit configured to estimate a noise component map in the input image from the low-bit-depth image using a neural network (NN) of a third bit depth that is lower than the first bit depth and is not lower than the second bit depth; and
a deriving unit configured to derive a noise-reduced image corresponding to the input image based on the input image and the noise component map.

2. The apparatus according to claim 1, wherein
the estimation unit estimates the noise component map by estimating an intermediate noise component map of the third bit depth from the low-bit-depth image using the NN, and performing bit depth conversion for the intermediate noise component map into the first bit depth, and
the deriving unit derives the noise-reduced image by subtracting the noise component map from the input image.

3. The apparatus according to claim 2, wherein
the NN includes a conversion layer for the bit depth conversion, and
the bit depth conversion includes nonlinear conversion.

4. The apparatus according to claim 2, wherein
the bit depth conversion of the NN nonlinearly converts the intermediate noise component map clipped by a threshold into the third bit depth.

5. The apparatus according to claim 4, wherein
the bit depth conversion of the NN performs, for the intermediate noise component map nonlinearly converted into the third bit depth, nonlinear conversion by an inverse function of the nonlinear conversion, thereby performing conversion into an intermediate noise component map having tones of the third bit depth having the same range as a range of the threshold.

6. The apparatus according to claim 3, wherein
the nonlinear conversion is performed by using a lookup table (LUT) or by an arithmetic operation, and
the arithmetic operation includes an operation by a piecewise linear function.

7. The apparatus according to claim 1, wherein
the third bit depth is equal to the second bit depth.

8. The apparatus according to claim 1, wherein
the conversion unit executes processing including nonlinear conversion at the time of converting the input image of the first bit depth into the low-bit-depth image of the second bit depth lower than the first bit depth.

9. The apparatus according to claim 8, wherein
in the processing including the nonlinear conversion, a value closer to a black level is converted into finer tones.

10. A learning apparatus for learning an NN of an information processing apparatus defined in claim 1, comprising:
a first obtaining unit configured to obtain a clean image of a first bit depth without noise and a noise component map to be added to the clean image;
a second obtaining unit configured to obtain a noisy image of the first bit depth by adding the noise component map to the clean image;
a second conversion unit configured to convert the noisy image into a low-bit-depth image of a second bit depth;
a second estimation unit configured to estimate, by using the NN, an estimation map as a result of estimating the noise component map from the low-bit-depth image; and
an update unit configured to update a parameter of the NN based on an error between the estimation map and the noise component map.

11. The apparatus according to claim 10, wherein
the update unit updates the parameter of the NN by backpropagation.

12. An information processing method for an information processing apparatus, comprising:
converting an input image of a first bit depth into a low-bit-depth image of a second bit depth lower than the first bit depth;
estimating a noise component map in the input image from the low-bit-depth image using a neural network (NN) of a third bit depth that is lower than the first bit depth and is not lower than the second bit depth; and
deriving a noise-reduced image corresponding to the input image based on the input image and the noise component map.
